(19) United States
(12) Patent Application Publication
(10) Pub. No.: US 2025/0287220 A1
(43) Pub. Date: Sep. 11, 2025

(54) SYSTEM AND METHOD FOR ASSISTED RF SITE ANALYSIS

(71) Applicant: DISH Network L.L.C., Englewood, CO (US)

(72) Inventor: Jeffrey Jablonski, Aurora, CO (US)

(73) Assignee: DISH Network L.L.C., Englewood, CO (US)

(21) Appl. No.: 18/601,472

(22) Filed: Mar. 11, 2024

(51) Int. Cl. H04W 16/20; H04B 17/391

(52) U.S. Cl. CPC H04W 16/20; H04B 17/391

(57) ABSTRACT

A system and method for assisted private network access point placement includes two or more devices equipped with radio frequency (RF) transmitter and receiver functionality. These devices (T/R devices) are capable of movement throughout various locations within a site to measure the transmission characteristics of RF signals, thereby determining optimal wireless network access point placement. The system further includes a command device configured to direct the T/R devices' location placement within the site. The command device is programmed with criteria for assessing whether a data set representative of wireless network access point characteristics meets predetermined minimum requirements.

### FIELD

The present disclosure relates generally to performing a site analysis for a private wireless network (PWN) site and, more particularly, to autonomous tools enabling consumers to perform their own site analysis.

### BACKGROUND

Determining the number and strategic placement of access points (APs) is crucial in designing an efficient and reliable private wireless network (PWN). The density and distribution of APs directly impact network coverage, capacity, and performance. Inadequate coverage may result in dead zones with poor or no connectivity, leading to a subpar user experience. On the other hand, excessive APs can cause interference and congestion, degrading the overall network performance. Therefore, a meticulous assessment of the physical layout, building structures, and user density is essential to strike the right balance and ensure seamless connectivity across the entire network.

Strategic placement of APs is equally vital for optimizing network performance. Factors such as building materials, obstructions and the presence of electronic devices can influence signal propagation. By strategically placing APs it is possible to mitigate these obstacles and enhance signal strength and stability. Additionally, considering the roaming behavior of devices that users employ to connect to the network, e.g., cellphones, it is essential to maintain consistent connectivity as users move with these devices within the network. Thus, proper placement, based on a comprehensive site survey and analysis, not only ensures comprehensive coverage but also contributes to efficient bandwidth utilization and a robust PWN infrastructure.

One of the most important (and costly) elements in the creation of a PWN is the analysis of the site to determine the optimal number and placement of APs to ensure the best coverage and performance of the network. This analysis must be done on-site, and by an expert in radio frequency (RF) site design. Existing planning tools require significant training and expertise to create an accurate AP installation map, complete with wall material composition as well as window and door placement. It can cost up to $2,000 for a conventional, manual site analysis by an RF site design expert. This expense is incurred even before the cost of the actual system is determined or system installation is performed.

### SUMMARY

The present disclosure can lower the cost of performing site analysis by enabling the consumer to perform their own site analysis with the tools of the present disclosure. This will shorten the sales cycle and broaden the market of potential customers who might install a private wireless network (PWN).

A method for assisted PWN access point (AP) placement includes positioning two or more devices with radio frequency (RF) transmitter and receiver functionality (T/R devices) at a plurality of locations within a site. Each of the two or more devices is configured to sequentially transmit an RF signal of a form typically transmitted by an AP to the other T/R device, which measures the received RF signal as an indication of the wireless transmission characteristics of RF signals transmitted between them. As the T/R devices move throughout the site they determine this “AP transmission characteristic” at different locations within the site. A command device causes the two or more devices to begin mapping AP transmission characteristics at the plurality of locations within the site. The command device determines when a data set representative of wireless network AP transmission characteristics in the site has been collected that meets a set of criteria programmed in the command device for minimum data set characteristics. In some implementations, the command device uses the data set to determine the number and placement of APs in the site, i.e., an AP installation map, so as to guarantee at least a minimum signal for wireless transmission in the site. In another implementation the command device transmits the data set to an external server in wireless communication with the command device so that the external server can generate the AP installation map.

In some implementations, the command device is further capable of providing instructions to a user for repositioning at least one of the two or more devices after readings at a location pair are taken. In some implementations, the command device also provides real-time feedback and instructions to the user based on the ongoing data collection by the T/R devices. In some implementations, the positioning of the T/R devices throughout the site is autonomous, wherein transport mechanisms are guided by an onboard processor within each of the T/R devices. In some implementations, the AP transmission characteristics include the strength of transmitted and received RF signals at the various locations within the site. In some implementations, the T/R devices include a power sensor configured to measure and record the strength of transmitted and received RF signals. In some implementations, the AP transmission characteristics readings are used by the external server to determine optimal locations for the placement of the wireless network with the AP installation map based on signal coverage and network performance criteria.

In further aspects, the T/R devices are additionally configured to measure and record other wireless RF signal transmission characteristics such as throughput, signal-to-noise ratio, and interference levels at different locations within the site. In some aspects, the T/R devices are capable of communicating with each other using a variety of RF wavelengths. In some aspects, the devices can selectively switch between transmitter and receiver roles to mimic the interaction between access points and client devices within the wireless network. In some aspects, the command device is capable of receiving user input to set forth characteristics of the site to be mapped.

A system for assisted private wireless network access point (AP) placement comprises two or more devices equipped with radio frequency (RF) transmitter and receiver functionality. These devices (T/R devices) are capable of being repositioned throughout various locations within a site to measure the AP transmission characteristics of RF signals. A command device is configured to cause a transport device and processor within each T/R device to direct T/R device location repositioning throughout the site. The command device is programmed with criteria for assessing whether a data set representative of wireless network AP transmission characteristics meets predetermined minimum requirements within the command device.

In some implementations, the command device of the system includes a user interface capable of providing instructions and receiving input regarding the repositioning of T/R devices throughout the site analysis. In some implementations, the command device is further configured to provide real-time feedback and instructions based on ongoing data collection from the T/R devices. In some implementations, the movement of each T/R device is controlled by the processor within each T/R device to execute autonomous movement within the site.

### BRIEF DESCRIPTION OF THE DRAWINGS

The foregoing and other objects and advantages of the present disclosure will become more apparent when considered in connection with the following detailed description and appended drawings in which like designations denote like elements in the various views, and wherein:

FIG. 1 is a perspective view of a site in which a system and method of the present disclosure is employed for performing assisted radio frequency (RF) site analysis using two Transmitter/Receiver (T/R) devices.

FIG. 2 is a T/R device system diagram that includes internal components of the T/R devices.

FIG. 3 is a T/R device positioning map that depicts movements and communication patterns of the T/R devices as they collect data on potential access point (AP) locations.

FIG. 4 is a diagram showing optimal AP positioning and wireless signal emission.

FIG. 5 is a heat map showing AP site placement and signal propagation after AP installation.

FIG. 6 is a flowchart of a method for performing an assisted RF site analysis and AP installation according to the present disclosure.

### DETAILED DESCRIPTION

The present disclosure provides systems, methods, and devices for enabling consumers to perform their own site analysis for private wireless network (PWN) installations through the use of automated tools, potentially reducing costs and shortening the sales cycle. Certain sites may be complex, having dozens or hundreds of rooms, across multiple floors, spanning a mix of indoor and outdoor spaces, and may include all manner of fixed or movable objects which can affect RF propagation. The complexity of a site can make it difficult to optimally plan where to install access points (APs) throughout the site. Equally distributing APs throughout a site may not account for the number of walls between APs, what may be hiding between the walls (e.g., structural components, ducting, etc.), leading to sub-optimal placement of APs and therefore poor coverage or performance at certain locations within a site. The disclosed method, for example, may involve the use of two or more devices equipped with radio frequency (RF) transmitter and receiver (T/R) functionality, capable of autonomous movement throughout a site. These T/R devices collect data on RF signal transmissibility at various locations to ascertain optimal placement for wireless network access points (APs) (e.g., 5G, Wi-Fi, Citizens Broadband Radio Service (CBRS), or future protocols such as 6G, 7G or the like, or any combination thereof). This empowers potential customers to carry out site assessments, broadening the market for PWN installations.

Once activated, the T/R devices are moved or are capable of autonomous navigation through an entire site or a user-defined portion of a site to compile a data set reflective of the wireless network AP transmission characteristics, i.e., the wireless signal transmission characteristics as if the transmitting T/R were an AP. While the devices can be manually moved about the site, in a preferred embodiment a command device, possibly preprogrammed and reprogrammable with specific criteria for the minimum data set characteristics required, directs a processor and transport device of the T/R devices to cause the T/R devices to move in a certain pattern while collecting data based on RF transmissions between them. Further, the command device can merely start the T/R devices and they can move throughout the site autonomously in a pattern set in the processor. When the collected data set meets the predefined criteria, it can then be processed to produce an AP installation map. Alternatively, the data can be forwarded to an external server for production of the AP installation map. In some implementations, the data processing may not be performed by the same system (processor) that is controlling the T/R device navigation and data collection. This user-assisted and autonomous mapping allows for efficient determination of the best network AP locations within a given site.

In practice, the T/R devices can leapfrog each other to obtain readings from multiple locations or at multiple frequencies, which creates a composite map of RF propagation which takes into account features that may obstruct signal flow, such as walls, floors, ducting, elevators, stairwells, industrial machinery, or any other fixed or movable object which could limit or interfere with RF propagation. The T/R devices may be easily portable and can be conveniently shipped to a customer, allowing even those with little to no expertise to participate actively in the mapping process by enabling the T/R devices to navigate and move around the site as guided by a site map interface stored in the controller or the T/R processor. In a further embodiment, the T/R devices can be provided with proximity detectors so as they move about the site in an initial search they can locate walls and other obstructions at the site to generate the site map and display it at a site map interface on the controller. The user is thereby empowered to map the site and conduct the RF performance data collection, completing the multi-layered site analysis necessary for optimal network AP installation.

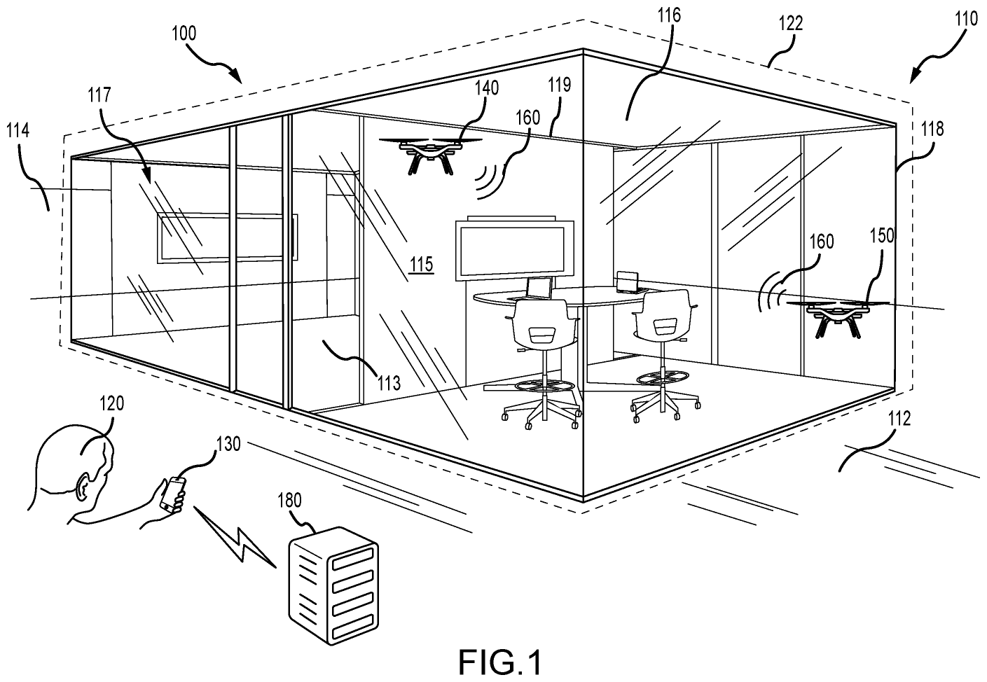

FIG. 1 is a view of a site upon which a system and method according to an embodiment of the disclosure perform an assisted RF site analysis using two T/R devices-“device A” 140 and “device B” 150. However, three or more T/R devices could also be used in other embodiments. The system 100 according to the embodiment of the disclosure of FIG. 1 includes a PWN site 110, which can be of various sizes and shapes. A PWN site 110 is often an office space or warehouse, but it can be any residential, commercial, or industrial site, including outdoor spaces or a combination of indoor and outdoor spaces such as a campus. While FIG. 1 illustrates an exemplary site with only a couple of rooms on a single floor, the PWN site 110 may include any number of rooms on any number of floors within a combination of indoor and outdoor spaces.

In some implementations, the PWN site 110 includes one or more internal private rooms 116 with walls and doors inside a public or private space 117. In addition, there are external spaces 112 and 114 within or around site 110, in which there may or may not be any intention to provide PWN service. A user may define a PWN site barrier 122, which sets forth the area in which a user intends to provide wireless network connectivity through installation of a PWN. In this example, spaces 112 or 114 are outside of the user defined PWN site barrier 122 and can be adjacent rooms, areas, spaces, or even buildings outside of the user defined PWN site barrier 122. However, the user defined PWN site barrier 122 may be selected to include any space where the user desires to provide wireless network coverage.

The PWN site 110 of FIG. 1 includes barriers 119 between room 116 and space 117, e.g., glass wall 113 and solid wall 115. Barrier 118 within PWN site 110 is between internal room 116 and external space 112. These barriers 118 and 119 can be made of any number of materials, such as metal, wood, drywall, plaster, ceramic, or other building materials.

FIG. 1 depicting system 100 includes a user 120. The user 120 possesses a command device 130 according to at least one implementation. In one or more implementations, the command device 130 contains a processor. The command device 130 may be a wireless cell phone device according to one aspect. In a further aspect, the command device 130 may be provided to the user 120 along with two or more T/R devices, such as T/R device A 140 and T/R device B 150. As described in further detail later on in the disclosure, T/R device A 140 and T/R device B 150 may be unmanned aerial vehicles (UAVs), such as drones, or they may be ground-based unmanned navigable devices, with movement capabilities similar to an autonomous vacuum cleaner. In some implementations, the T/R device A 140 and T/R device B 150 may also lack unassisted movement capabilities and require the user 120 to reposition the devices upon receiving instructions on command device 130. The T/R devices may also include their own processor and a transport device, which in the case of drones would include a battery and an electric motor that drives propellers.

According to an embodiment of the disclosure, user 120 provides information to a command device 130 that conveys a desired user defined PWN site barrier 122. In some aspects, a user defined PWN site barrier 122 defines the space within the site 110 that the user desires to map, including one or more internal rooms 116, as well as space 117 within the site 110 that the user desires to map. However, in this case the user does not desire to map the one or more external spaces 112 and 114. To this end, in some implementations, the command device 130 is capable of receiving instructions from the user 120 as to which rooms 116 and space 117 the user intends to map and cover through PWN installation and which spaces 112 or 114 are those that the user does not intend to map and cover through installation of a PWN.

In a salient aspect consistent with the present disclosure, T/R devices such as T/R device A 140 and T/R device B 150 are configured to autonomously navigate or to have the user reposition the devices upon receipt of instructions from command device 130 within the user defined PWN site barrier 122. While navigating the site, the T/R devices 140 and 150 communicate with each other using RF signal transmission and reception 160. The RF transmission and reception are configured to replicate the characteristics of PWN APs. Collection of this data results in a data set that is translated into an installation map for ideal placement of APs within the PWN site 110. The installation map superimposes the collected wireless signal transmission data onto the site map so that the best locations for APs can be determined in order to provide complete or nearly complete wireless coverage in the PWN site 110.

In one or more embodiments, the AP transmission characteristics that the T/R device transceiver components are to replicate in performance conform to 3rd Generation Partnership Project (3GPP) standards and protocols related to 5G connectivity. 3GPP is an umbrella term for a number of standards organizations which develop protocols for mobile telecommunications. Its best-known work is the development and maintenance of the following: GSM and related 2G and 2.5G standards, including GPRS and EDGE; UMTS and related 3G standards, including HSPA and HSPA+; LTE and related 4G standards, including LTE Advanced and LTE Advanced Pro; 5G NR and related 5G standards, including 5G-Advanced and an evolved IP Multimedia Subsystem (IMS) developed in an access independent manner. 3GPP also focuses on staying current with and developing protocols for cutting-edge and future developments in the mobile telecommunications, which include 6G, 7G, CBRS, and the like. It is contemplated that the present disclosure is applicable to all future systems that employ APs or the like.

In one or more implementations, the T/R devices 140 and 150 can transmit to one another across a range of frequencies and power levels to measure the signal strength, throughput, signal-to-noise ratio, interference levels, and other key performance indicators (KPIs) received across those frequencies and power levels. In some aspects, the T/R devices 140 and 150 are capable of transmitting and receiving across all commonly used Wi-Fi and 5G RF bands, including but not limited to 2.4 GHZ, and 5 GHZ, as well as current or forthcoming 6G, 7G, and CBRS bands.

In further implementations, the T/R devices 140 and 150 are capable of measuring signal attributes utilizing different spectrum bands. In yet further implementations, the system disclosed herein can produce AP installation maps for PWNs utilizing different varying spectrum bands. This facilitates installation of PWNs with clean and unencumbered spectrum bands, some of which may be purchased from the Federal Communications Commission (FCC). In yet further implementations, the system and method disclosed herein can measure and map PWN features operating within the General Authorized Access (GAA) tier. The GAA tier is licensed-by-rule to permit open, flexible access to the band for the widest possible group of potential users. GAA users can operate throughout the 3550-3700 MHz band.

With further regard to the PWN Site 110 and user defined PWN site barrier 122 within it, a computer aided design (CAD) drawing of the site may be submitted wherein the T/R device mapping process validates and layers upon it. In such implementations, pre-existing solutions such as GPS location detection and static device triangulation may be utilized. In further aspects, the T/R device mapping process maps the site layout with no or minimal data input related to the site barriers, features, and dimensions. In such a case the T/R devices may be equipped with 3D mapping capabilities through the use of LiDAR components, ultrasonic sensors, proximity sensors, infrared sensors, optical components (like time-of-flight cameras, structured light 3D scanners, stereo vision cameras, or ultrasonic sensors), or the like, or any combination thereof. LiDAR and radar are both remote sensing technologies that measure distance and movement. LiDAR uses laser beams to measure distances and movement in real time.

In particular, not only is information obtained as to the location of the device in the site, but its location above the ground or floor. In some cases, ideal AP placement may be in the ceilings of buildings, and the T/R device mapping process disclosed herein, which automates one or more stages of a conventional site analysis, may result in recommendations for attaching the AP device(s) to one or more telescoping poles for optimal signal strength and positioning.

A processor of the T/R device may have sufficient memory to store the collected data and sufficient processing power to generate a site map and an AP installation map, which transmits back to the command device 130 for display. In one or more other implementations, the command device 130 stores data collected by the T/R devices during the mapping stage in memory on the command device 130. Its processor may also determine the site map and installation map. However, in further implementations, the command device transmits the data collected during the mapping stage to an external server 180 for processing of the data set via an application residing on the server. As depicted in FIG. 1, the external server 180 is capable of generating a site map and an AP installation map derived from the data set received from the command device 130. The external server 180 then transmits the site map and/or AP installation map to the command device 130 for display. In alternative aspects, the external server 180 stores the AP installation map in memory and is capable of making the AP installation map available to or accessible to the user 120 or various other PWN installation technicians, e.g., via an internet connection.

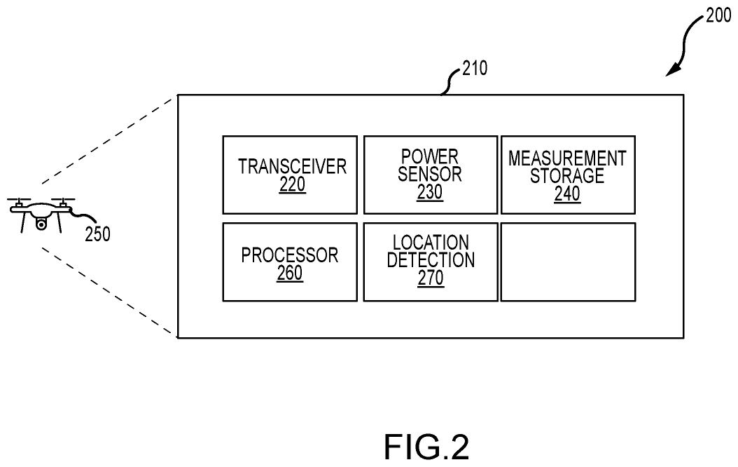

FIG. 2 is a T/R device system diagram 200 that includes internal components of a T/R device 250 according to an embodiment of the present disclosure. T/R device 250 is an example of a T/R device 140/150 illustrated in FIG. 1. In one aspect, the T/R device 250 has a housing 210 for securing and positioning internal components. In some implementations, the T/R device 250 includes a combination RF transmitter and an RF receiver 220. Often, such combinatory RF transmitter-receiver components are referred to as “transceivers,” and the terms “RF transmitter/receiver (T/R),” “RF transceiver,” and “transceiver” are used interchangeably throughout this disclosure.

In some implementations, T/R device 250 includes a power sensor 230. Power sensor 230 is configured to measure RF signal strength received by the transceiver 220 from signal propagation 160 (previously depicted in FIG. 1). The primary function of a power sensor is to monitor the power of the transmitted and received signals within an RF system. Knowing the power levels helps to ensure that the PWN system will operate within its defined specifications. More generally, power measurements can be indicative of signal quality. A power sensor such as power sensor 230 helps maintain signal integrity by ensuring a signal is strong enough to be clear and reliable over the necessary distance while adhering to regulatory limits on signal strength. The power sensor 230 signal strength readings are taken at various locations and are indicative of signal strength that a wirelessly connected device would receive at various locations from a PWN AP after installation. More particularly, the power sensor readings taken at one location by a first T/R device 140 operating in a receiver capacity would be representative of the PWN signal that a wirelessly connected device would receive from an installed AP. Further, a second T/R device 150 would be operating in a transmission capacity, and would be broadcasting to T/R device 140, during the point at which T/R device 140 was taking the readings. T/R device 150's signal transmission would thus be representative of the signal that an installed AP in a PWN would be transmitting.

In most implementations, the transceiver 220 sends and receives RF signals, but does not measure the strength of the received RF signal, which is done by the power sensor 230. The power output from transceiver 220 is a fixed level sufficient for mapping the area, such as within the user-defined site barrier 122 in FIG. 1. In most implementations. There is generally no need to measure the transmitted signal strength, because it remains at a fixed level which serves as a benchmark for measuring received signals and signal distortions therein. In some variations, a transmitted signal is increased in an environment where the signal reception function of transceiver 220 within a T/R device 250 is designed to limit its capacity to receive any RF signal transmitted at the normal output from transceiver 220, since it is the signal distortion measurements that are of primary interest.

In some implementations, T/R device 250 also includes a measurement storage component 240. In some aspects, the measurement storage component 240 is a memory, such as random access memory (RAM). Measurement storage 240 may be one of any number of other types of memory, including but not limited to solid-state device (SSD), flash, cache, or a removable external device such as a USB drive. Measurement storage 240 at least temporarily stores the collected signal data.

In one or more implementations, T/R device 250 also includes a processor 260. In some implementations, processor 260 is electrically connected to all of the other internal components within the T/R device 250. In various implementations, processor 260 is programmatically configured to control the function of one or more of the internal components within T/R device 250. Such control is performed through execution of programming code. The code for controlling the function of one or more of the internal components within T/R device 250 may be read by processor 260 from a local memory, such as measurement storage 240 or a remote memory via a wireless connection such as wi-fi or LTE, or any combination thereof. Further, the processor 260 may receive and interpret signals from command device 130, and then carryout functions requested by the command device 130. If processor 260 has sufficient computing power it can determine the site map based on the data stored in measurement storage 240. Further, if the measurement storage 240 is of sufficient size, the site map can also be stored in measurement storage 240.

In various implementations, the T/R device 250 may include a location detection feature 270. In some implementations, the location detection component 270 is a preprogrammed global positions system (GPS). In one or more variations, the location detection component 270 incorporates a radar. In one or more further aspects, the T/R device 250's radar feature—when used as location detection component 270—sends out a signal and receives a reflection from nearby surroundings, measuring direction and distance (position). Alternatively, the location detection component 270 may include one or a combination of additional sensors, such as thermal, infrared, or LiDAR. Both LiDAR and Radar can determine the distance, angle, and speed of the device. In one or more aspects, the sub-features of location detection component 270 are linked to processor 260 and record location data that contribute to the data set collected for processing of a PWN AP installation map. Further, the LiDAR and Radar signals can be used so that the devices avoid collisions with each other or physical barriers such as walls in the site.

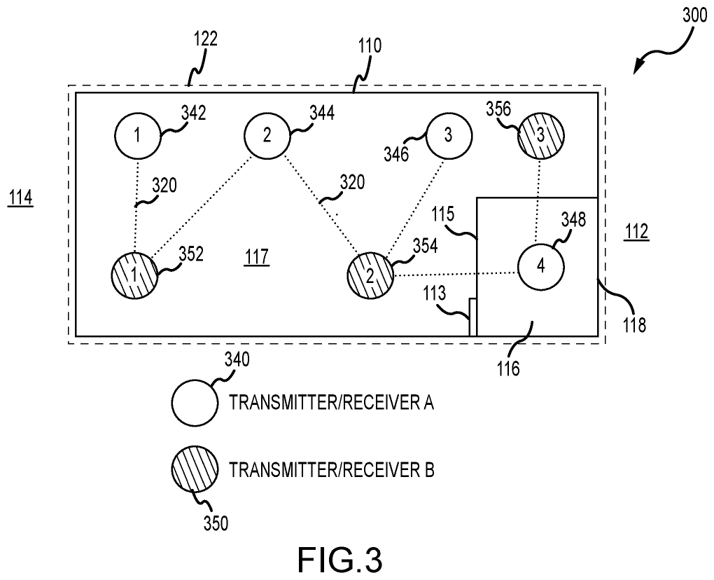

FIG. 3 is a T/R device positioning map 300 that depicts movements and communication patterns of the T/R devices as they collect data on potential Access Point (AP) locations according to an embodiment. One variation of a PWN site 110 shows multiple possible locations for T/R devices A 340 and B 350. See FIG. 1. T/R device A 340 and T/R device B 350 are examples of T/R Devices 140 and 150 illustrated in FIG. 1. In one aspect, the entirety of PWN site in map 300 is also the User Defined PWN Site Barrier 122 (previously described in relation to FIG. 1). The PWN site 110 has the internal or private room 116 and public space 117 within the site barrier 122, and the spaces 112, 114 outside the barrier as indicated in FIG. 1. The private room is defined by solid walls 115, 118 and glass wall 113.

In a salient aspect consistent with the present disclosure, T/R devices such as T/R device A 340 and T/R device B 350 begin in position “1,” denoted by the numbers inside of the circles. The circles are representative of T/R devices A 340 and B 350 at various stages of positioning and repositioning within PWN site 110.

In one implementation, and by way of example, T/R device A starts at a first position “1” (enumerated as 342). T/R device B also starts at a first position “1” (enumerated as 352). A user (such as user 120 depicted in FIG. 1) would place both T/R devices A and B in their respective first positions, 342 and 352. While in the first positions, T/R devices A and B alternate transmission and reception of RF signals. This two-way communication 320 is depicted with dotted lines between the various positions. Any two locations, such as locations 342 and 352 amount to a location pair. Once the transmission and reception of RF signals is complete for both devices at a location pair, data about the signal strength, characteristics of the surroundings and locations of the devices is stored in measurement storage 240 depicted in FIG. 2.

Once a first location pair is completed, one of the T/R devices repositions itself to a second position, while the other T/R device remains in its first position. In FIG. 3, this is shown by T/R device A moving from position “1” (enumerated as 342) to position “2” (enumerated as 344). The combination of T/R device A Repositioning 2 (enumerated as 344) and T/R device B Position 1 (enumerated as 352) forms a new location pair. While in this second pair of positions, TR Devices A and B again alternate transmission and reception of RF signals. This two-way communication 320 is again depicted with dotted lines between the various positions. Once the transmission and reception of RF signals is complete for both devices at the second location pair (The combination of T/R device A Repositioning 2, i.e. 344, and T/R device B Position 1, i.e. 352), data about the signal strength, characteristics of the surroundings, and locations of the devices is again recorded and stored in measurement storage 240 depicted in FIG. 2.

The next step is for T/R device B to move to its new position 2 (enumerated 354), forming a new (third) location pair with T/R device A's position 2 (enumerated 344). The two-way communication 320 is once again performed, and related data on surrounding site characteristics is recorded and stored in measurement storage 240. Once data for location pair three is collected, T/R device A then repositions itself again at T/R device A Repositioning 3 (enumerated as 346). Repositioning and location pair data is collected for the pairs of 346:354, 348:354, and 348:356. This process of leapfrogging between the T/R devices 340 and 350 repeats until a comprehensive data set meeting predefined minimum characteristics mimicking possible AP placements is collected. At this point, a complete data set has been generated for PWN site 110.

In this exemplary implementation, at T/R device A Position 4 (enumerated as 348), it is presumed that signal strength data will be affected substantially by the barriers 113, 115, 118 of an internal room 116. Collecting data on the location and effect of such barriers in a PWN site, such as PWN site 110, is a salient aspect of the disclosure. Similar barriers at various sites are expected to result in signal transmission and reception data distortions which eventually are used to inform ideal placement of PWN APs for maximum wireless network signal strength and reliability. For example, it may be necessary to locate an AP within room 116.

In one or more embodiments, the T/R devices are not fully autonomous. Instead, instructions on command device 130 dictate that a user 120 (as depicted in FIG. 1) should use a control stick on command device 130 to direct the T/R devices as to when and where to move the devices next, as well as which device to move. In one or more implementations, the T/R devices are capable of being able to switch the role between transmission and reception, which replicates an Access Point as a transmitter versus a client device as a receiver. In some implementations, devices may only serve as either a transmitter or a receiver.

In some implementations, in cases where a T/R device is initially placed in an incorrect location, command device 130 is able to receive alerts from the T/R device processors which inform the user that the devices must be moved and repositioned to the proper location. This feature is a function of the devices being spatially aware of their locations and surroundings. When the T/R devices are drones, they can be flown to the proper starting position under the direction of the command device. However, in one embodiment, they may autonomously fly to the correct location.

Where proposed PWN site locations are spatially large, there will ultimately need to be multiple APs to adequately cover the site. Only by taking readings from multiple prospective placement locations can the ideal number and locations be calculated. The assisted RF site analysis process, according to one or more implementations of the present disclosure, tests the real experience of proposed APs in the site as opposed to theoretical performance metrics that can be generated by a CAD signal propagation planning tool.

In primary applications of the present disclosure, it is assumed that when mapping an area, the only partner T/R device signals emitted or received would be from the performance of the leapfrog process depicted in FIG. 3. The T/R devices would not be randomly or constantly emitting RF signals. RF signal emissions are performed in a controlled fashion throughout the duration of the mapping process. Additionally, in most applications of the present disclosure, it is assumed that either there are no other wireless networks operating in the area, or that their signals would be interpreted as background noise by either the command device 130, the transceivers of T/R devices 140 and 150, or a combination of the other hardware and software components operating within the same. Any difference measured above a background noise signal would be the signal measurement of importance, indicative of obstacles within a particular site of interest. Alternatively, or in addition, the signals used for measurement and mapping of a site could be of different frequencies to any signals emitted from preexisting wireless networks operating at the site prior to application of the present disclosure.

In applications of the present disclosure where more than two T/R devices are used, the number of transmission/reception pairs multiplies. For example, instead of transmission pairs of 1-2 and 2-1 for two T/R devices, three T/R devices would need pairs in a pattern consistent with the following: 1-2, 1-3, 2-1, 2-3, 3-1, and 3-2.

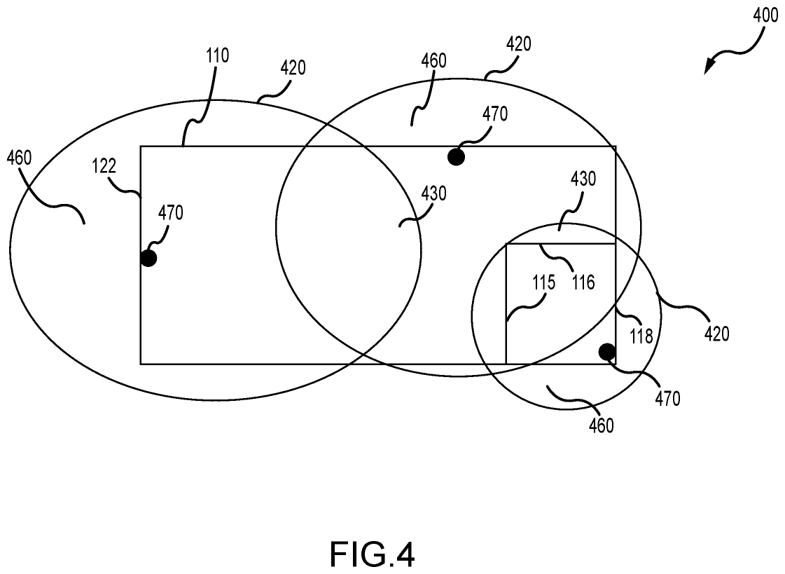

FIG. 4 is an example of a simulated pre-AP installation diagram showing optimal AP positioning and wireless signal emission 400 according to an embodiment. In some implementations, such a diagram would be generated after and with the results from the data collection performed during the T/R device leapfrogging stage depicted in FIG. 3. The PWN site 110, private room 116, and barriers 114, 118 are included in diagram 400. However, diagram 400 depicts an exemplary rendering of ideal placement for installation of Access Points 470 at PWN site 110, according to at least one implementation of the present disclosure. Diagram 400 also displays the AP 470 wireless signal emission zones 420. The zones 420 depict simulated AP 470 wireless signal propagation capacities and radii derived from the data collected at the T/R device leapfrogging stage.

In some PWN sites, such as PWN site 110 depicted in diagram 400, various AP wireless signal emission zones 420 may induce zone overlap 430. Zone overlap is sometimes an undesirable, yet likely unavoidable, product of the nature of radial wireless signal propagation. Overlap can result in signal distortion or clogging of bandwidth otherwise used for PWN data transmission. An algorithm used to derive diagrams such as diagram 400 for proposed installation locations of APs 470 will minimize overlap, like overlap 430, while maximizing PWN site coverage of a user defined PWN site barrier. Like wireless signal emission zone overlap 430, both simulated and actual PWN AP installation will often result in wireless signal emission outside of a user defined PWN Site, which is depicted as the sites 460 extending beyond the PWN site barrier 122, which is coterminous with the site 110.

In some implementations, however, simulated and actual PWN AP installation consistent with the present disclosure incorporate attributes of advanced APs that utilize beamforming. Beamforming is a signal processing technique that allows for finding Wi-Fi devices and strengthening signals in specific directions from the AP to client. Advanced APs utilizing beamforming are able to be more directional in their signal propagation. With Beamforming technology, an AP will locate PWN client devices and then strengthen the signal in that direction, extending wireless coverage, reducing unnecessary RF interference and creating a stronger, faster, and more reliable wireless communication.

In further implementations, T/R device data recordation enables creation of a composite map of all device position combinations for all readings taken across multiple frequencies and with a combination of throughput determinations incorporated into the readings. In some aspects, an algorithm used to generate the proposed AP installation map will take into account a customer's desired PWN performance requirements. In such aspects, if a customer submits the thresholds for a combination of one or more required signal strength, throughput, signal-to-noise ratio, and interference levels, the algorithm calculating a proposed AP installation map will make calculation adjustments that will increase the recommended power output of AP devices, the number of APs, or both. This post-hoc analysis is performed using the same data set of readings taken during the T/R device navigation and mapping stage without a need for a new set of readings.

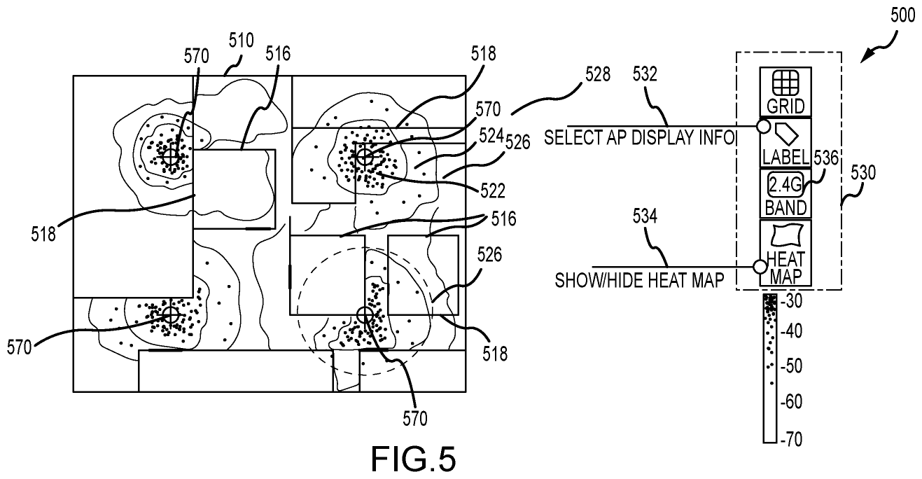

FIG. 5 is a heat map 500 showing AP site placement and signal propagation strength after AP installation according to an embodiment. A PWN site 510 is representative of the desired area for PWN coverage according to one implementation. PWN site 510 is an example of a PWN site 110 illustrated in FIG. 1. In this PWN map example, there are several private rooms 516 and barriers 518 that predictably limit signal strength emitted from APs 570. The internal rooms 516 and barriers 518 are examples of the private room 116 and barriers 113, 115 and 118, respectively, as illustrated in FIG. 1. In some AP installation heatmap implementations, such as heatmap 500, APs have wireless signal emissions zones 520. The portions with the highest concentration of dots showing emissions from APs 570 within a wireless signal emission zone 520 is indicative of excellent wireless connection signal strength 522. The second most dense concentration of dots showing emissions from APs 570 within a wireless signal emission zone 520 is indicative of good wireless connection signal strength 524. The third most dense concentration of dots showing emissions from APs 570 within a wireless signal emission zone 520 is indicative of moderate wireless connection signal strength 526. The lowest density of dots showing emissions surrounding APs 570 is indicative of weak or no signal strength 528. In one or more aspects, this signal strength tapers off when it reaches obstacles such as the walls of a private room 516 or a barrier 518.

Heatmap 500 also contains a set of user interface selection options 530 according to an exemplary implementation. In some aspects, the user interface is accessible on command device 130 depicted in FIG. 1. In further variations, the user interface for heatmap 500 is accessible on a user 120's personal electronic device (ref. FIG. 1), such as a mobile phone, tablet, a laptop, or a desktop. In some implementations, a user interface 530 contains an option to select to view performance characteristics of one or more access points 570, depicted as button 532. In one or more implementations, a user interface 530 contains an option to select to view or close the heatmap 500, depicted as button 534. In further implementations, a user interface 530 contains an option to select to view or close network band characteristics, depicted as button 536. User interface 530 can contain any one or several of the preceding button view options in some implementations. User interface 530 may contain other network feature viewing or function control options in further embodiments.

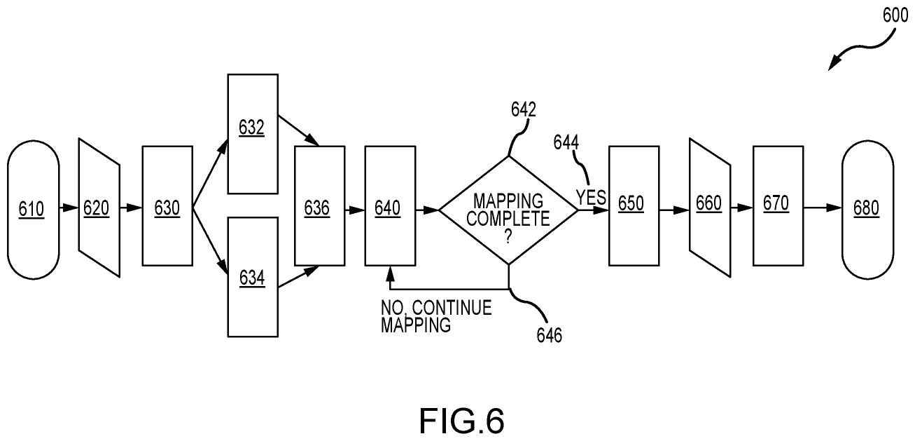

FIG. 6 is a flowchart 600 for performing an assisted RF site analysis and AP installation according to one or more embodiments. Starting step 610 represents the beginning of the process for RF site analysis according to one implementation. Step 620 represents a user inputting a user defined PWN site barrier, such as user defined site barrier 122 depicted in FIG. 1. In primary implementations, Step 620 also includes a user providing information about a floor plan or site map. The floor plan or site map itself is not determined by the system disclosed herein. Such a floor plan or site map is a preexisting building plan or the like. The customer knows what physical area they want covered by a PWN. The map created by the system disclosed herein (and as detailed with respect to Step 660 below) is laid over the site map to determine where the APs should be placed. Step 630 represents a user receiving T/R devices such as T/R devices 140 and 150 as illustrated in FIG. 1—which will begin to perform the RF site analysis. Step 630 is meant to cover any means by which the T/R devices are made available at the site. As noted above, the previous step is merely providing a floor plan and it can be performed before the devices are received. Step 632 represents data transmission from a user to a user command device processor, while step 634 represents data transmission from a user to a T/R device processor. These steps involve executing code on the respective device processors that will enable the T/R devices to begin navigating a PWN site, which is depicted as step 636 in the flowchart. Step 636 of releasing the T/R devices is performed in accordance with instructions received on the command device 130, as depicted in FIG. 1 and as executed in steps 632 and 634.

Once the T/R devices are released at step 636, the T/R devices begin mapping the site through the RF signal transmission leapfrog process, depicted as step 640, according to a salient aspect of the disclosure. Step 640 proceeds in recursive fashion until mapping is complete, which is determined by an inquiry element enumerated step 642. During this inquiry, the current data set collected is continuously compared to a minimum standard data set for defining and characterizing a site and its various potential Access Point locations. During the recursion depicted with step 640 (T/R device mapping), step 642 (continuous mapping progress monitoring), and arrow 646 (incomplete mapping query and recursion to T/R device mapping), the T/R devices continue to form additional location pairs, as detailed in the description of FIG. 3 above, until a minimum standard data set benchmark is met, as determined by recursive execution of code in a processor. Once the benchmark is met, the process proceeds through arrow 644 and onto step 650, which represents transmission of the data set collected to an external server (such as external server 180 as illustrated in FIG. 1) and the processing of the data set. Following the data set processing step, flowchart step 660 represents generation of an access point installation map and transmission of the map back to the user.

In one embodiment the AP installation map can be formed by placing a first AP at a central location while others are placed in the center of areas that have low transmission characteristics until the site is completely covered. In a further embodiment, machine learning processes can be used. In particular, virtual modeling can be used to predict coverage from an AP based on the AP transmission map of the site. Then using the model, computers can change the location of the AP and/or add other APs thousands or millions of times to arrive at an optimal placement. strategy of play. This can result in a predictive model that can be used to determine the AP installation made based on new data collected at a site.

Once the user receives the AP installation map and a sale of the system is consummated, the recommended number of AP devices are provided to the user and installed, which is depicted as step 670. Once the APs are installed, the PWN installation is completed and the process ends at step 680.

The above are only exemplary implementations of some embodiments and are not intended to limit the scope of protection of the disclosure. Any modifications or substitutes apparent to those skilled in the art shall fall within the scope of protection of the disclosure.

While the disclosure is explained in relation to certain embodiments, it is to be understood that various modifications thereof will become apparent to those skilled in the art upon reading the specification. Therefore, it is to be understood that the disclosure is intended to cover such modifications as fall within the scope of the appended claims.

1. A method for assisting private wireless network access point (AP) placement, comprising:
positioning two or more devices with radio frequency (RF) transmitter and receiver functionality (T/R devices) at a plurality of locations within a site, wherein each of the two or more devices is configured to transmit an RF signal of a form typically transmitted by an AP to the other T/R device which measures the received RF signal as an indication of the wireless AP transmission characteristics of RF signals transmitted between the two or more devices at the plurality of different locations within the site;
causing the two or more devices to begin measuring the wireless network AP transmission characteristics at the plurality of locations within the site;
determining when a data set representative of the measured wireless network AP transmission characteristics in the site has been collected that meets a set of criteria for minimum data set characteristics; and
generating an AP installation map based on the collected data set when the set of criteria has been met.

2. The method of claim 1, the steps of causing the devices to begin mapping and determining when a data set has met the set of criteria are carried out by a command device, and wherein the command device further provides instructions to a user for repositioning at least one of the two or more devices after readings at a location pair are taken.

3. The method of claim 2, wherein the command device further provides real-time feedback and instructions to the user based on the collected data set.

4. The method of claim 1, wherein the positioning of the T/R devices throughout the site is autonomous, guided by an onboard processor within each of the T/R devices.

5. The method of claim 1, wherein the AP transmission characteristics include the strength of transmitted and received RF signals at the various locations within the site and the T/R devices include a power sensor configured to measure and record the strength of transmitted and received RF signals.

6. The method of claim 2, further including a step of having the command device transmit the data set to an external server, wherein the step of generating the AP installation map based on the collected data set is carried out by the external server, and wherein the AP transmission characteristics readings are used by the external server to determine optimal locations for the placement of wireless network with the AP installation map based on signal coverage and network performance criteria.

7. The method of claim 5, wherein the AP transmission characteristics further comprise at least one of a throughput, a signal-to-noise ratio, and interference levels at the plurality locations within the site.

8. The method of claim 1, wherein the T/R devices are capable of communicating with each other using a variety of RF wavelengths.

9. The method of claim 1, wherein the T/R devices can selectively switch between transmitter and receiver roles to mimic the interaction between access points and client devices within the wireless network.

10. The method of claim 2, wherein the command device is capable of receiving user input to set forth characteristics of the site to be mapped.

11. A system for assisted private wireless network access point (AP) placement, comprising:
two or more devices equipped with radio frequency (RF) transmitter and receiver functionality, these devices (T/R devices) being capable of repositioning throughout various locations within a site to measure the AP transmission characteristics of RF signals; and
a command device configured to cause a processor within each T/R device to direct the T/R device to reposition its location throughout the site, the command device further being programmed with criteria for assessing whether a data set representative of wireless network AP transmission characteristics meets predetermined minimum requirements.

12. The system of claim 11, wherein the command device includes a user interface capable of providing instructions and receiving input regarding the repositioning of T/R devices throughout the site analysis.

13. The system of claim 12, wherein the command device is further configured to provide real-time feedback and instructions based on ongoing data collection from the T/R devices.

14. The system of claim 11, wherein each T/R device is a remotely controllable aerial drone and the movement of each T/R device is controlled by the processor within each T/R device to execute autonomous three-dimensional movement within the site.

15. The system of claim 11, wherein the T/R devices further comprise a power sensor that measures and records RF signal strength at the various locations throughout the site.

16. The system of claim 15, wherein the power sensor readings contribute to determining optimal wireless network access point locations based on signal coverage and performance metrics.

17. The system of claim 11, wherein the T/R devices are configured to measure and record additional RF signal characteristics, including throughput, signal-to-noise ratio, and interference levels at different site locations.

18. The system of claim 11, wherein the T/R devices are further capable of communicating with each other using a variety of RF wavelengths.

19. The system of claim 11, wherein the T/R devices include functionality to selectively switch roles between transmitting and receiving, thereby simulating the interaction dynamics between APs and client devices within a wireless network.

20. A method for creating an optimized wireless network access point (AP) installation plan within a defined site, comprising:
distributing a plurality of transceiver devices within the defined site, wherein each transceiver device is capable of transmitting and receiving radio frequency (RF) signals;
generating instructions, by a command device, for causing the repositioning of the transceiver devices within the defined site;
collecting, by a processor in each of the transceiver devices transmitting data to the command device, RF signal propagation characteristics throughout the defined site;
aggregating, by the processor in the command device, a data set from the collected RF signal propagation data, wherein the data set characterizes the RF environment within the defined site in terms of least one of the following characteristics: signal strength, signal-to-noise ratio, interference levels, and obstructions;
transmitting, by the command device, the data set to an external server in wireless communication with the command device;
processing, by the external server, the data set to generate a predictive model of wireless network performance within the defined site; and
generating, by the external server, an AP installation map, wherein the external server uses the predictive model to compute optimal placement of wireless network APs based on signal coverage, network performance criteria, and the physical characteristics of the defined site, wherein the repositioning of the transceiver devices within the defined site involves starting with two transceivers at two separate locations within the site and taking a reading, moving one of the transceivers to a new location and taking a reading, moving the other of the transceivers to a new location and taking a reading, and repeating this leapfrogging positioning until a comprehensive data set meeting predefined minimum characteristics mimicking possible AP placements is collected.
